(19) United States
(12) Patent Application Publication
(10) Pub. No.: US 2015/0198980 A1
(43) Pub. Date: Jul. 16, 2015

(54) DETACHABLE FORWARD CRADLE DOCK

(71) Applicant: INTEL CORPORATION, SANTA CLARA, CA (US)

(72) Inventors: Russell Aoki, Tacoma, WA (US); Ralph Miele, DuPont, WA (US); Luke Schwartzel, Dupont, WA (US)

(21) Appl. No.: 14/126,277

(22) PCT Filed: Jul. 30, 2013
(86) PCT No.: PCT/US2013/052783

§ 371 Date: Dec. 13, 2013

(51) Int. Cl. G06F 1/16

(52) U.S. Cl. CPC G06F 1/1654; G06F 1/1616; G06F 1/1669

(57) ABSTRACT

Particular embodiments described herein provide for an electronic device that could include a circuit board coupled to a plurality of electronic components (which includes any type of components, elements, circuitry, etc.). One particular example implementation of the electronic device may include a display portion and a keyboard portion (e.g., having about the same length and width as the display portion). The keyboard portion can include a cradle dock that allows the keyboard portion to be removably connected to the display portion in a first configuration. A viewing angle of the display portion can be changed when the cradle dock is rotated about an axis of rotation on the keyboard.

### TECHNICAL FIELD

Embodiments described herein generally relate to detachable cradle dock mechanisms.

### BRIEF DESCRIPTION OF THE DRAWINGS

Embodiments are illustrated by way of example and not by way of limitation in the FIGURES of the accompanying drawings, in which like references indicate similar elements and, in which:

FIG. 1A is a simplified orthographic view illustrating an embodiment of an electronic device, in accordance with one embodiment of the present disclosure;

FIG. 1B is a simplified orthographic view illustrating an embodiment of an electronic device, in accordance with one embodiment of the present disclosure;

FIG. 1C is a simplified orthographic view illustrating an embodiment of an electronic device, in accordance with one embodiment of the present disclosure;

FIG. 1D is a simplified orthographic view illustrating an embodiment of an electronic device, in accordance with one embodiment of the present disclosure;

FIG. 1E is a simplified orthographic view illustrating an embodiment of an electronic device, in accordance with one embodiment of the present disclosure;

FIG. 2 is a simplified side view illustrating an embodiment of an electronic device, in accordance with one embodiment of the present disclosure;

FIG. 3A is a simplified cutaway side view illustrating an embodiment of an electronic device, in accordance with one embodiment of the present disclosure;

FIG. 3B is a simplified cutaway side view illustrating an embodiment of an electronic device, in accordance with one embodiment of the present disclosure;

FIG. 3C is a simplified cutaway side view illustrating an embodiment of an electronic device, in accordance with one embodiment of the present disclosure;

FIG. 3D is a simplified cutaway side view illustrating an embodiment of an electronic device, in accordance with one embodiment of the present disclosure;

FIG. 4A is a simplified orthographic view illustrating an embodiment of an electronic device, in accordance with one embodiment of the present disclosure;

FIG. 4B is a simplified orthographic view illustrating an embodiment of n electronic device, in accordance with one embodiment of the present disclosure;

FIG. 4C is a simplified orthographic view illustrating an embodiment of an electronic device, in accordance with one embodiment of the present disclosure;

FIG. 5A is a simplified cutaway side view illustrating an embodiment of an electronic device, in accordance with one embodiment of the present disclosure;

FIG. 5B is a simplified cutaway side view illustrating an embodiment of an electronic device, in accordance with one embodiment of the present disclosure;

FIG. 5C is a simplified side cut away view illustrating an embodiment of an electronic device, in accordance with one embodiment of the present disclosure;

FIG. 6A is a simplified cutaway side view illustrating an embodiment o n electronic device, in accordance with one embodiment of the present disclosure;

FIG. 6B is a simplified cutaway side view illustrating an embodiment of an electronic device, in accordance with one embodiment of the present disclosure;

FIG. 7 is a simplified cutaway side view illustrating an embodiment of an electronic device, in accordance with one embodiment of the present disclosure; and

FIG. 8 is a simplified block diagram illustrating potential electronics and logic that may be associated with one embodiment of the electronic device.

The FIGURES of the drawings are not necessarily drawn to scale, as their dimensions can be varied considerably without departing from the scope of the present disclosure.

### DETAILED DESCRIPTION OF EXAMPLE EMBODIMENTS

The following detailed description sets forth example embodiments of apparatuses, methods, and systems relating to keyboard protection configurations for an electronic device. Features such as structure(s), function(s), and/or characteristic(s), for example, are described with reference to one embodiment as a matter of convenience; various embodiments may be implemented with any suitable one or more of the described features.

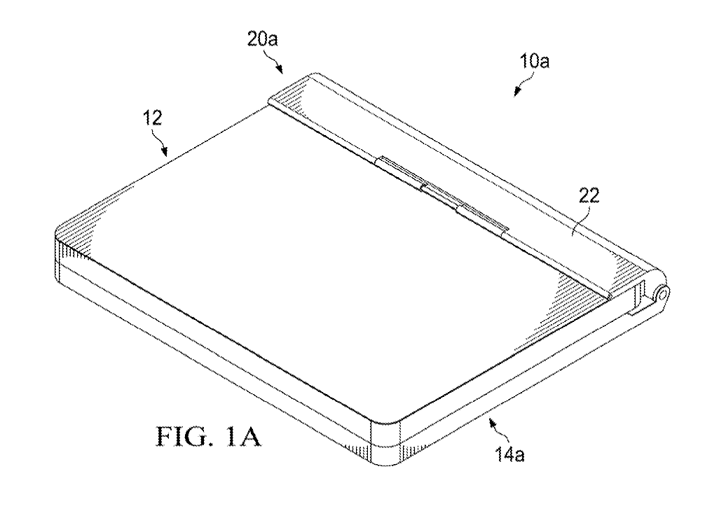

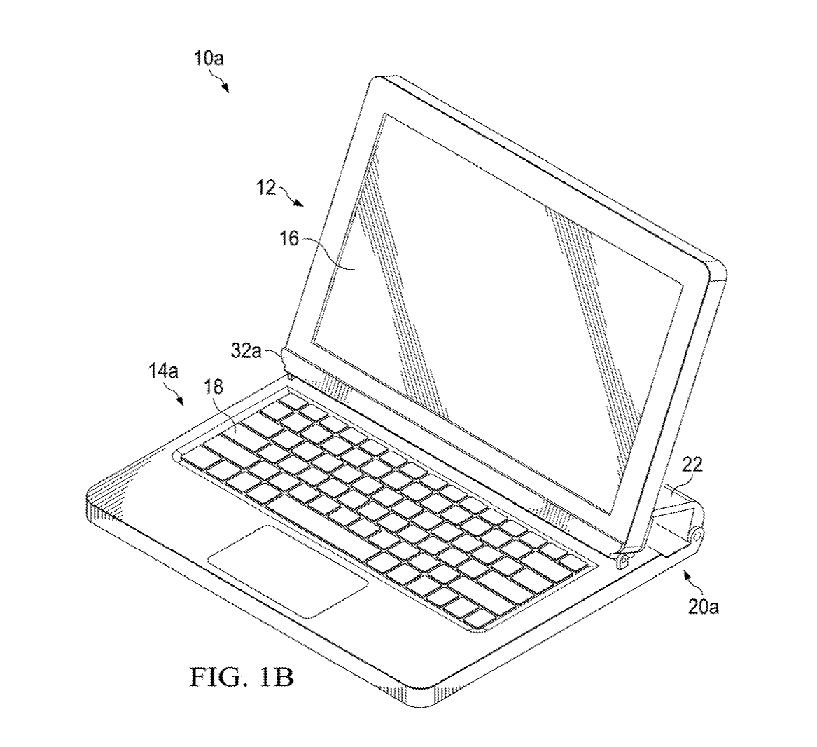

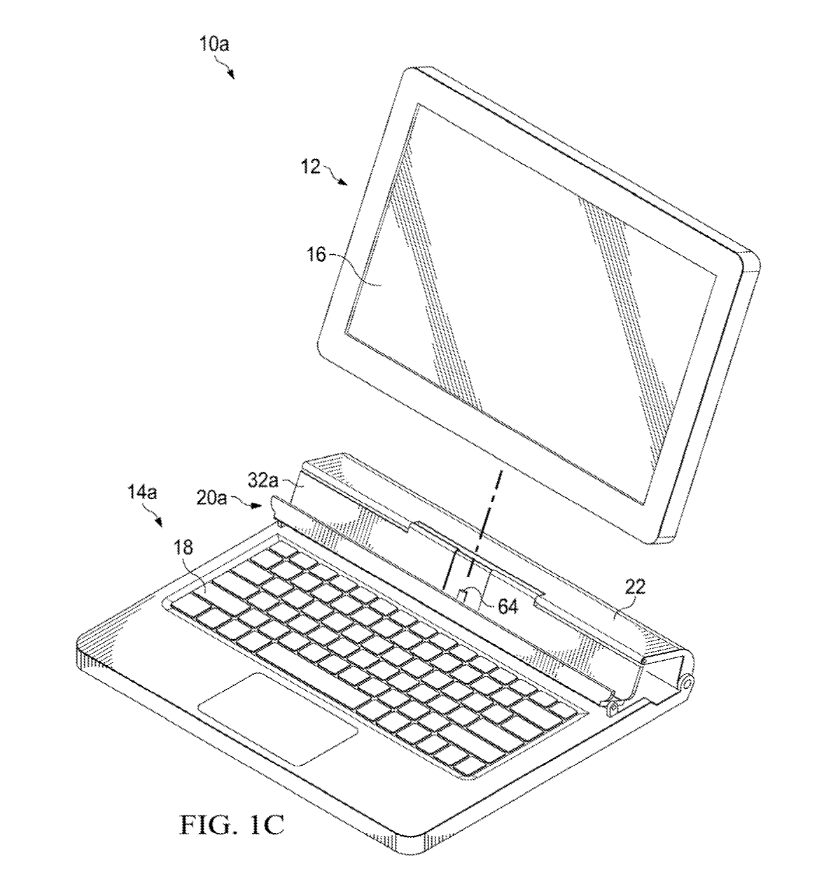

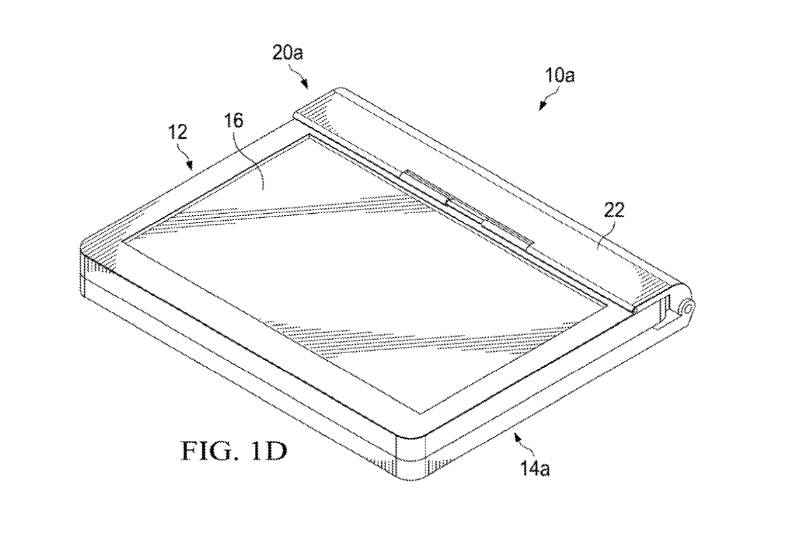

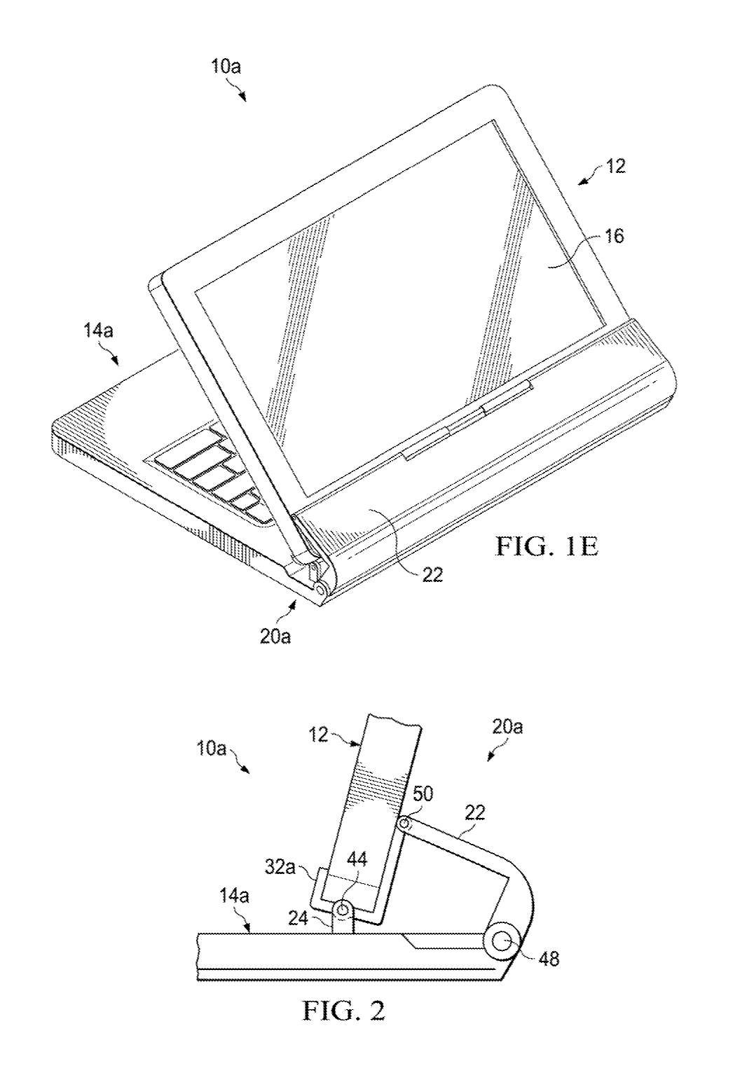

FIG. 1A is a simplified orthographic view illustrating an embodiment of an electronic device 10a in a closed laptop configuration in accordance with one embodiment of the present disclosure. Electronic device 10a may include a display portion 12, a keyboard portion 14a, a cradle dock 20a, and a kickstand 22. Display portion 12 and keyboard portion 14a may be connected by cradle dock 20a. Cradle dock 20a can define an axis of rotation (or multiple axes of rotation) that is shared between display portion 12 and keyboard portion 14a.

in one or more embodiments, electronic device 10a may be any suitable electronic device having a display such as a mobile device, a tablet computer and/or a tablet device (e.g., i-Pad), a personal digital assistant (PDA), a smartphone, an audio system, a movie player of any type, a computer docking station, etc. Display 16 may be a liquid crystal display (LCD), organic light-emitting diode (OLED), or some other type of display. Electronic device 10a can contain a battery and various electronics (e.g., wireless module (e.g., Wi-Fi module, Bluetooth module, etc.) processor, memory, camera, a microphone, speakers, etc.) to allow electronic device to operate.

Turning to FIG. 1B, FIG. 1B is a simplified orthographic view illustrating an embodiment of an electronic device 10a in an open laptop configuration in accordance with one embodiment of the present disclosure. Display portion 12 may include a display 16. Keyboard portion 14a may include a keyboard 18. Cradle dock 20a may include a cradle 32a.

Turning to FIG. 1C, FIG. 1C is a simplified orthographic view illustrating electronic device 10a in a detach mode, separated into two segments in accordance with one embodiment of the present disclosure. Cradle dock 20a may include an interconnect 64. Interconnect 64 may be a printed circuit board (PCB) interconnector.

Using cradle dock 20a, an electrical current and signals can be passed between display portion 12 and keyboard portion 14a to recharge an on-board battery or capacitor, power any number of items (e.g., display 16, a wireless module, a camera, speakers, etc.), and provide a communication path between display portion 12 and keyboard portion 14a. In other examples, electrical current and signals can be passed through a plug-in connector (e.g., whose male side protrusion connects to display portion 12 and whose female side connects to keyboard portion 14 or vice-verse) or a wireless connector (e.g., WiFi, Bluetooth, etc.). Note that any number of connectors (e.g., Universal Serial Bus (USB) connectors (e.g., in compliance with the USB 3.0 Specification released in November 2008), Thunderbolt™ connectors, a non-standard connection point such as a docking connector, etc.) can be provisioned in conjunction with electronic device 10a. [Thunderbolt™ and the Thunderbolt logo are trademarks of Intel Corporation in the U.S. and/or other countries.]. Virtually any other electrical connection methods could be used and, thus, are clearly within the scope of the present disclosure

Turning to FIG. 1D, FIG. 1D is a simplified orthographic view illustrating electronic device 110 in a tablet configuration in accordance with one embodiment of the present disclosure. As illustrated in FIG. 1D, display 16 is facing away from keyboard portion 14a. The XY footprint (i.e., the length and width) of display portion 12 is the same (or about the same) as keyboard portion 14a such that a portion of display portion 12 does not extend (or only slightly extends) past an edge of keyboard portion 14a and a portion of keyboard portion 14a does extend (or only slightly extends) past an edge of display portion 12.

Turning to FIG. 1E, FIG. 1E is a simplified orthographic view illustrating electronic device 10a in a viewing mode in accordance with one embodiment of the present disclosure. As illustrated in FIG. 1E, display 16 is facing away from keyboard portion 14a in a viewing mode configuration. Keyboard portion 14a can help provide a stable base for display portion 12. Cradle dock 20a can be configured to allow display portion 12 to be connected to keyboard portion 14a in a clamshell configuration (as illustrated in FIG. 1B) or a viewing mode configuration (as illustrated in FIG. 1E).

The following information may be viewed as a basis from which one or more embodiments may be explained. Although the embodiments described are related to laptops, tablets, convertible laptops, hybrid laptops, etc. there may be other embodiments that deal with phone, PDAs, audio systems, etc. A hybrid laptop, (e.g., a convertible computer, etc.) is a mobile computer that can include a laptop configuration (illustrated in FIG. 1B) and a tablet configuration (illustrated in FIG. 1D). To convert from the laptop configuration to the tablet configuration, often the display portion can be separated from a base or keyboard portion. While hybrid laptops are a compelling way of delivering convertibility from a laptop configuration to a tablet configuration, in some designs, because the display portion is a fully functioning tablet, the device can be top heavy due to the fact that most the electronics are in the display portion and leave little system mass in the keyboard portion. As a result, many devices today are extremely unstable when using touchscreen functions, especially when using a device on an uneven surface, such as a lap of a user. Further, because the tablet configuration can consist of two separate components, the user may be concerned about losing the keyboard portion or leaving the keyboard portion at one location when the user is at another location.

In an embodiment, the electrical device can be configured to mitigate against tipping and allow for screen angle adjustment without compromising the XY footprint of the system or adding weight to the keyboard portion of the electronic device. In addition, the electrical device may be configured to allow the keyboard portion to be stored behind the display portion when the electronic device is in a tablet configuration. The electronic device can consist of two connection mechanisms. The first connection mechanism may be a mirrored cradle dock. The cradle dock can enable the display portion to be attached to the keyboard portion in two orientations and allow the user to have two options. In the first orientation, the display portion can be used as a standalone tablet with the keyboard portion stored behind the display portion (as illustrated in FIG. 1E). In the second orientation, the cradle dock can allow additional viewing modes for the end user, such as the viewing mode configuration illustrated in FIG. 1E.

The second connection mechanism may be a linkage that couples the cradle dock to the keyboard portion. The linkage can force a translation of the cradle dock (or a portion of the cradle dock) towards the user when the display portion is rotated open (e.g., the cradle dock translates forward when the device opens into an open clamshell configuration). The translation of a portion of the cradle dock forward creates a “porch” or footing behind the display portion that can stabilize the electronic device and create an anti-tip feature. Secondly, having the additional linkage creates a structural attachment point on the display portion that stabilizes the display portion to minimize the bounce of the display during dynamic events such as interaction with a touch display. A portion of the cradle dock can be located in front of the display portion to create a smaller XY footprint when comparing against other implementations. Also, when the device closes, the cradle dock can translate backward to preserve a minimum XY footprint.

The cradle dock may be of any appropriate shape and dimensions, where its construction could reflect an integral piece (e.g., of plastic, metal, fiber, any combination of these, etc.) or its construction could reflect a number of components being fit together. The cradle dock could have various sub-parts (e.g., two sub-parts on either end of the keyboard portion or the display portion). The cradle dock could be hidden from sight, or exposed. In certain implementations, the cradle dock could extend the length of the keyboard portion or the display portion, or it could be much smaller. It is imperative to note that any such alternatives and permutations are dearly within the broad scope of the present disclosure.

Turning to FIG. 2, FIG. 2 is a simplified side view illustrating an embodiment of electronic device 10a in an open clamshell configuration in accordance with one embodiment of the present disclosure. Display portion 12 and keyboard portion 14a may be connected by cradle dock 20a. Cradle dock 20a can include cradle 32a, kickstand 22, a sliding block 24, a first cradle hinge 44, a second cradle hinge 50, and a kickstand pivot point 48. Cradle 32a can support display portion 12. As the viewing angle of display portion 12 is adjusted and electronic device 10a is transitioned from one configuration to another configuration, cradle 32a can rotate about first cradle hinge 44 and second cradle hinge 50.

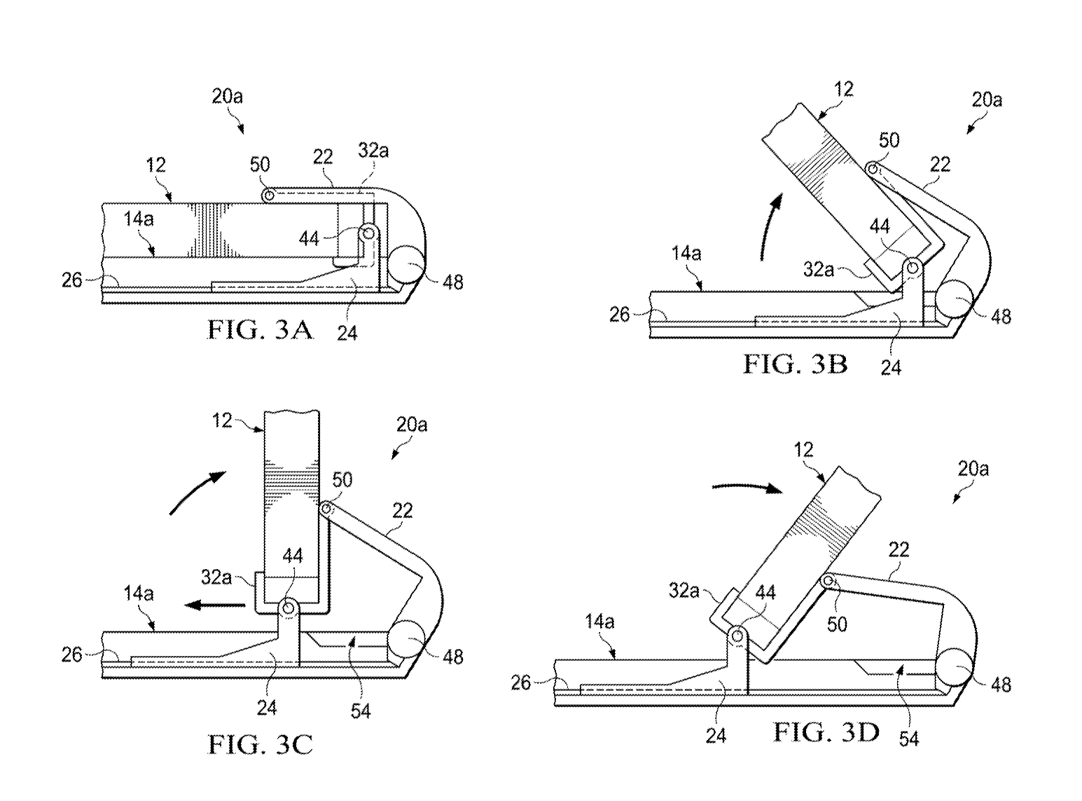

Turning to FIG. 3A, FIG. 3A is a simplified cut away orthographic view illustrating cradle dock 20a in accordance with one embodiment of the present disclosure. As illustrated in FIG. 3A, cradle dock 20a is in a closed configuration. Cradle dock 20a can include cradle 32a, kickstand 22, first cradle hinge 44, sliding block 24, kickstand pivot point 48, second cradle hinge 50, and a slider rail 26. Sliding block 24 can slide or move along slider rail 26.

Turning to FIG. 3B, FIG. 3B is a simplified cut away orthographic view illustrating cradle dock 20a in accordance with one embodiment of the present disclosure. As illustrated in FIG. 3B, display portion 12 has been lifted up, causing cradle 32a (that is supporting display portion 12) to be rotated on first cradle hinge 44 and second cradle hinge 50. Kickstand 22 also rotates on kickstand pivot point 48.

Turning to FIG. 3C, FIG. 3C is a simplified cut away orthographic view illustrating cradle dock 20a in accordance with one embodiment of the present disclosure. As display portion 12 is rotated to an upright position, display portion 12 begins to push against kickstand 22. This causes sliding block 24 to begin to slide on slider rail 26 and move cradle 32a to a position where kickstand 22 can provide support for display portion 12. A groove 54 in keyboard portion 14a can include a profile that accommodates cradle 32a such that when electronic device 10a is in a closed configuration (e.g., a closed laptop configuration or a tablet configuration), smooth profile on the top surface of keyboard portion 14a can be created.

Turning to FIG. 3D, FIG. 3D is a simplified cut away orthographic view illustrating cradle dock 20a in accordance with one embodiment of the present disclosure. As display portion 12 continues to be rotated to a desired viewing angle, sliding block 24 slides on slider rail 26 such that display portion 12 can be supported by linkage 40.

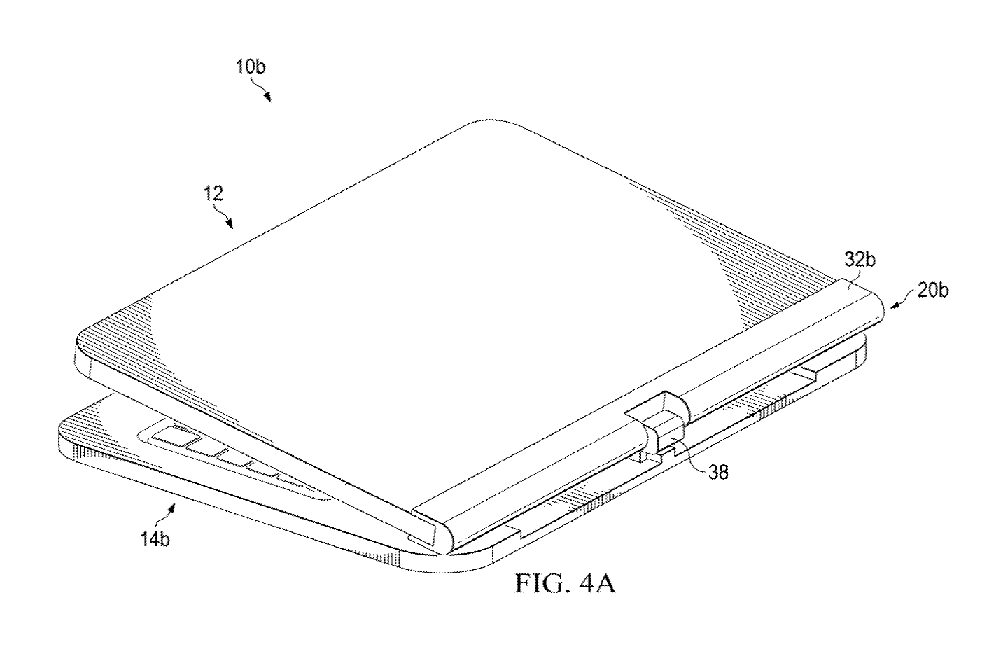

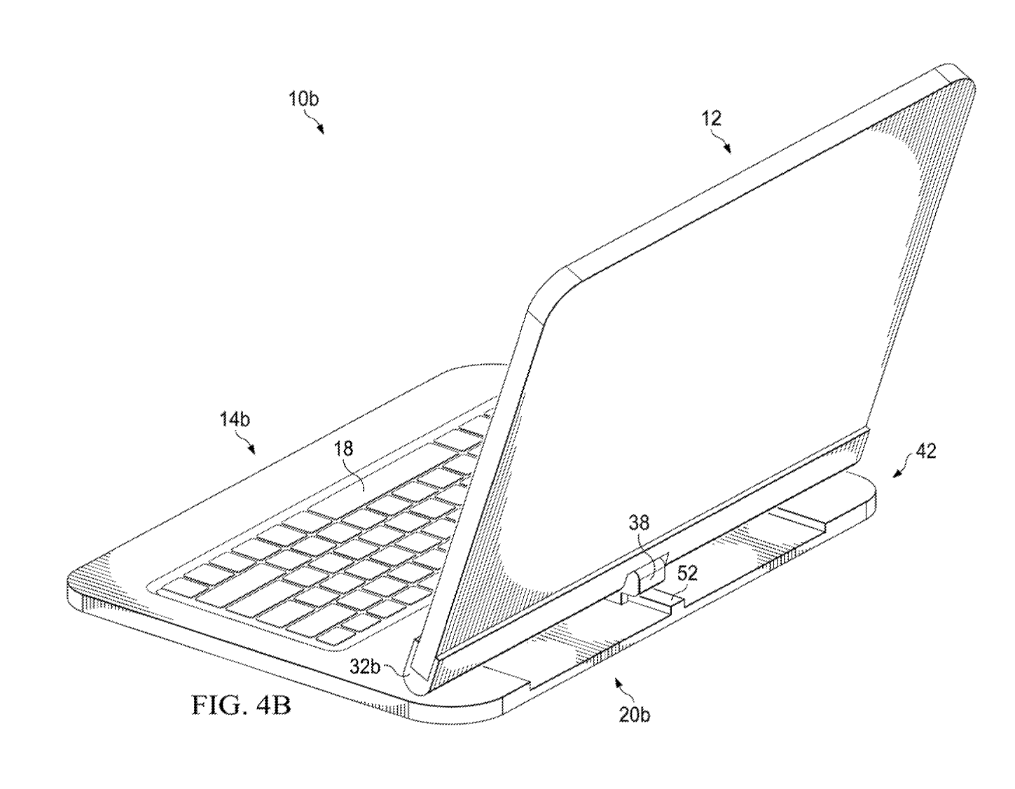

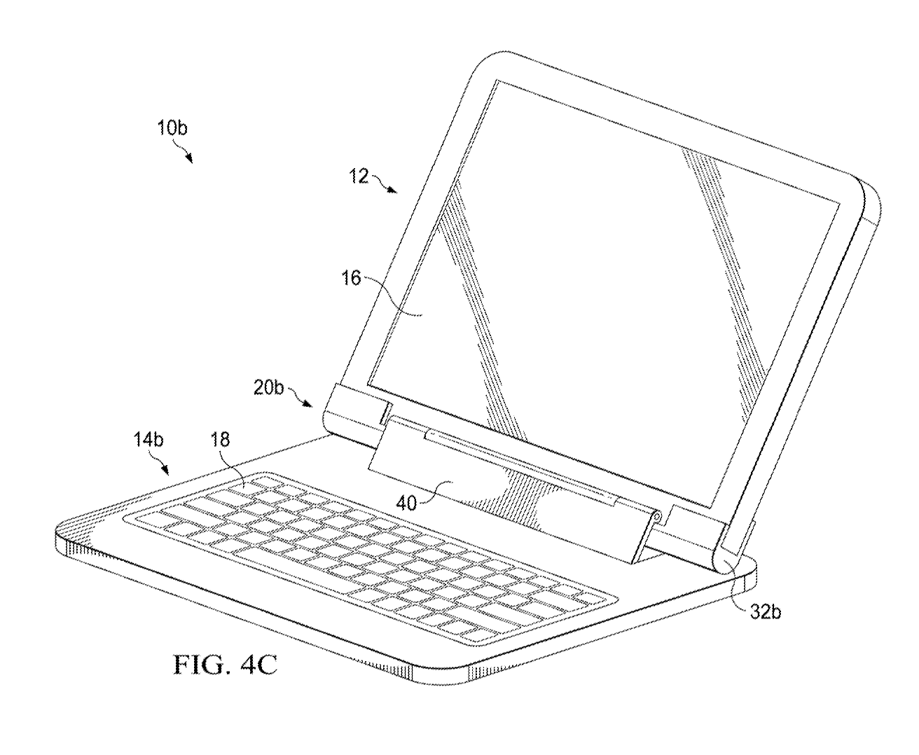

Turning to FIG. 4A, FIG. 4A is a simplified orthographic view illustrating an embodiment of an electronic device 10b in an almost closed laptop configuration in accordance with one embodiment of the present disclosure. Electronic device 10b includes display portion 12, a keyboard portion 14b, a cradle dock 20b, a cradle 32b, and a cradle support 33. As illustrated in FIG. 4A, display portion 12 and laptop portion 14b have the same (or almost the same) XY footprint (i.e., length and width). When electronic device 10b is in a close clamshell configuration or a tablet configuration, the edges of keyboard portion 14b do not extend for only slightly extend) past display portion 12 and the edges of display portion 12 do not extend (or only slightly extend) past the edges of keyboard portion 14b.

Turning to FIG. 4B, FIG. 4B is a simplified orthographic view illustrating an embodiment of an electronic device 10b in an open clamshell configuration in accordance with one embodiment of the present disclosure. As illustrated in FIG. 4B, display portion 12, cradle 32b, and cradle support 38 have slid forward on a bearing rail 52. Such a configuration can provide some stability for electronic device as a porch 42 is created behind display portion 12 that can stabilize electronic device 10b and create an anti-tip feature. Cradle 32b can create a structural attachment point on display portion 12 that can help stabilize display portion 12 to minimize the bounce of display portion 12 during dynamic events such as interaction with display 16 when display 16 is a touch display.

Turning to FIG. 4C, FIG. 4C is a simplified orthographic view illustrating an embodiment of an electronic device 10b in an open clamshell configuration in accordance with one embodiment of the present disclosure. Cradle dock 20b can include cradle 32b and linkage 40. Linkage 40 can provide support for display portion 12 when electronic device 10b is in an open clamshell configuration.

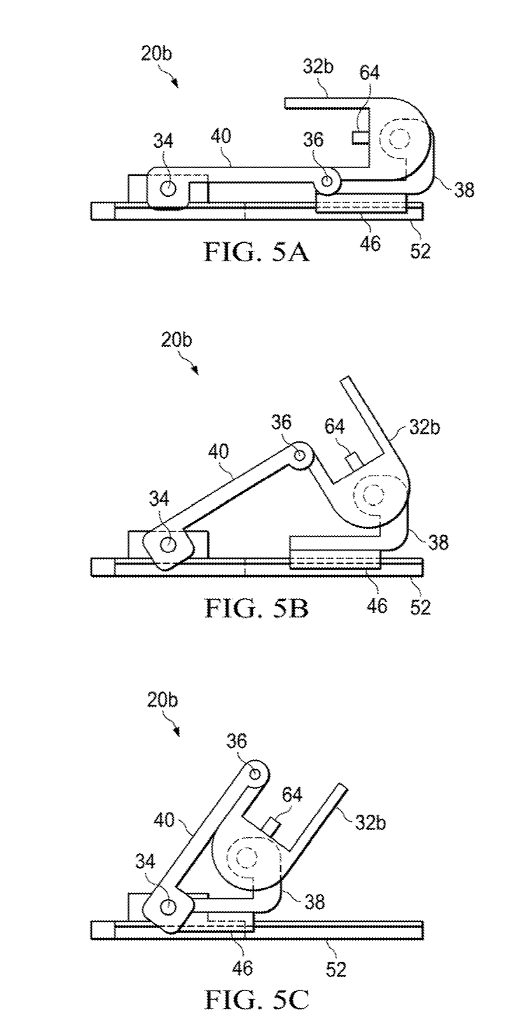

Turning to FIG. 5A, FIG. 5A is a simplified cut away side view illustrating cradle dock 20b in accordance with one embodiment of the present disclosure. Cradle dock 20b can include cradle 32b, a linkage pivot point 34, a cradle pivot point 36, cradle support 38, linkage 40, a sliding block 46, sliding rail 52, and interconnect 64. As illustrated in FIG. 5A, cradle dock 20b is in a closed clamshell configuration or a tablet configuration.

Turning to FIG. 5B, FIG. 5B is a simplified cut away side view illustrating cradle dock 20b in accordance with one embodiment of the present disclosure. As illustrated in FIG. 5B, linkage 40 has been rotated about linkage pivot point 34 and cradle 32b has been rotated about cradle pivot point 36. As linkage 40 is rotated about linkage pivot point 34, linkage 40 pulls on cradle 32b causing sliding block 46 to slide along sliding rail 52 and allow cradle 32b to rotate on cradle pivot point 36.

Turning to FIG. 5C, FIG. 5C is a simplified cut away side view illustrating cradle dock 20b in accordance with one embodiment of the present disclosure. As illustrated in FIG. 5C, linkage 40 has been rotated about linkage pivot point 34 and cradle 32b has been rotated about cradle pivot point 36. As linkage 40 is rotated about linkage pivot point 34, linkage 40 pulls on cradle 32b and sliding block 46 slides along bearing rail 26 until cradle dock 20b is in an open clamshell configuration and porch 42 (not shown) can be created to mitigate against tipping of electronic device 10b. Linkage 40 can prevent over rotation of cradle 32b on cradle pivot point 36 and provide support for display portion 12 when electronic device 10b is in an open clamshell configuration.

Note that the terms ‘bearing’, ‘bearing rail’, ‘linear bearing’, etc. are general and, therefore, broad in their scope. A bearing, as used herein, includes any machine element that constrains relative motion between moving parts to any desired motion. The design of the bearing may, for example, provide for linear movement of the moving part or for free rotation around a fixed axis. Additionally (or alternatively), the bearing may prevent a motion by controlling the vectors of normal forces that bear on the moving parts. Instead of a bearing, a wheel, or fluid dynamics could be used, for example, in its place.

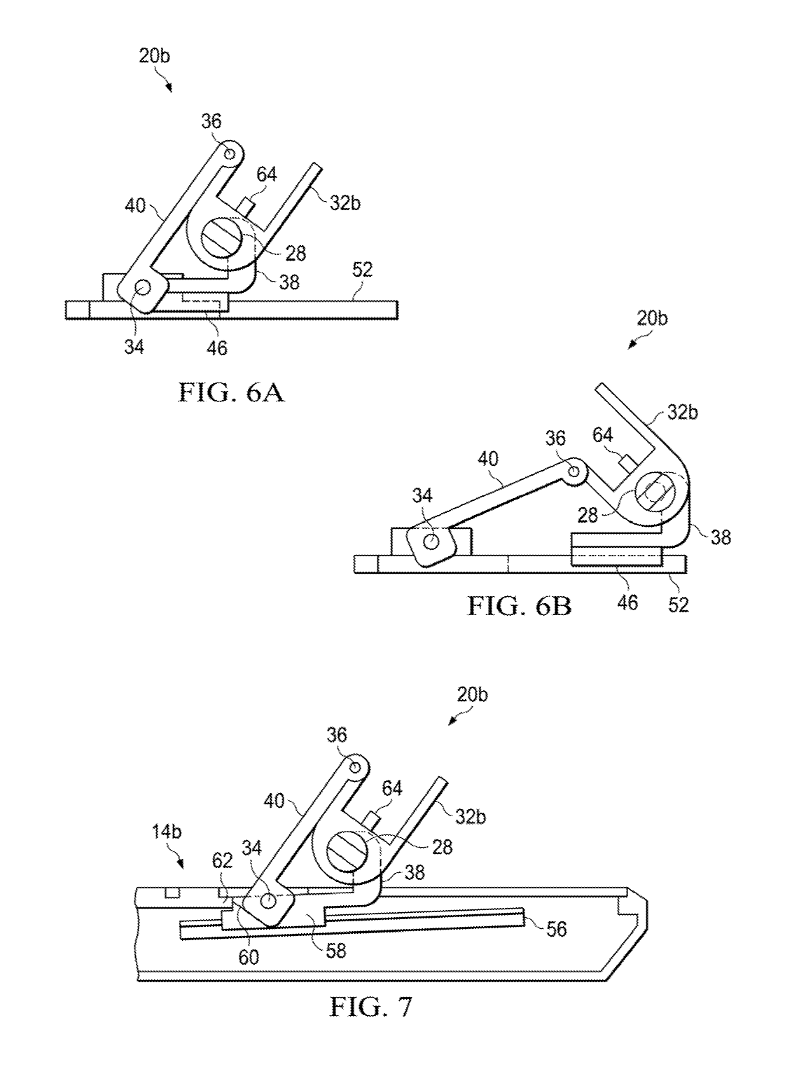

Turning to FIG. 6A, FIG. 6A is a simplified orthographic view illustrating cradle dock 20b in an open clamshell configuration in accordance with one embodiment of the present disclosure. As illustrated in FIG. 6A, cradle dock 20b is in an open clamshell configuration. Cradle dock 20b can include linkage 40, a friction element 28, cradle 32b, linkage pivot point 34, cradle pivot point 36, cradle support 38, sliding block 46, sliding rail 52, and interconnect 64. Friction element 28 may apply torque or resistance to the movement of cradle 32b or rotation of cradle 32b around cradle pivot point 36 when electronic device 10b is in an open clamshell configuration. In an embodiment, friction element 28 can be used to secure display 16 at a desired viewing angle.

Turning to FIG. 6B, FIG. 6B is a simplified orthographic view illustrating cradle dock 20b in a closed or partially closed configuration in accordance with one embodiment of the present disclosure. Friction element 28 may not apply torque or resistance (or little torque or resistance) when cradle 32a is in a closed position through an upright position (e.g., zero to about ninety degrees (0°-90°) to allow for easy rising of display portion 12 from a closed configuration to an open configuration. Past about 90°, friction element 28 may provide enough torque to secure display 16 at a desired viewing angle during dynamic events such as interaction with display 16 when display 16 is a touch display.

Turning to FIG. 7, FIG. 7 is a simplified orthographic view illustrating keyboard portion 14b in accordance with one embodiment of the present disclosure. As illustrated in FIG. 7, cradle dock 20b is in an open clamshell configuration. Cradle dock 20b can include friction element 28, cradle 32b, linkage pivot point 34, cradle pivot point 36, cradle support 38, linkage 40, an angled bearing rail 56, and an angle-bearing block 58. Angled bearing rail 56 can be configured to guide cradle dock 20b towards the center of keyboard portion 14b. By having the center of mass of electronic device 10b closer to the center of keyboard portion 14b, angled bearing rail 56 can help stabilize electronic device 10b and create an anti-tip feature. Angle bearing block 58 can include a ridge 60. When ridge 60 comes into contact with stopper 62 on keyboard portion 14b, angle-bearing block 58 is prevented from sliding further down angled bearing rail 56.

Note that the embodiments of FIGS. 1A-7 are simply reflective of one of the many possible design choices for electronic devices 10a and 10b. In other cases, the shape and the size of cradle dock 20a and 20b may be varied considerably. For example, in certain cases, the length of cradle dock 20a or 20b may occupy only a portion of the keyboard framework. Consider a case in which a design of cradle dock 20a or 20b only inhibits a top center portion of the keyboard framework. In other cases, a design could be provided where cradle dock 20a or 20b inhibits a majority of a top portion of the keyboard framework.

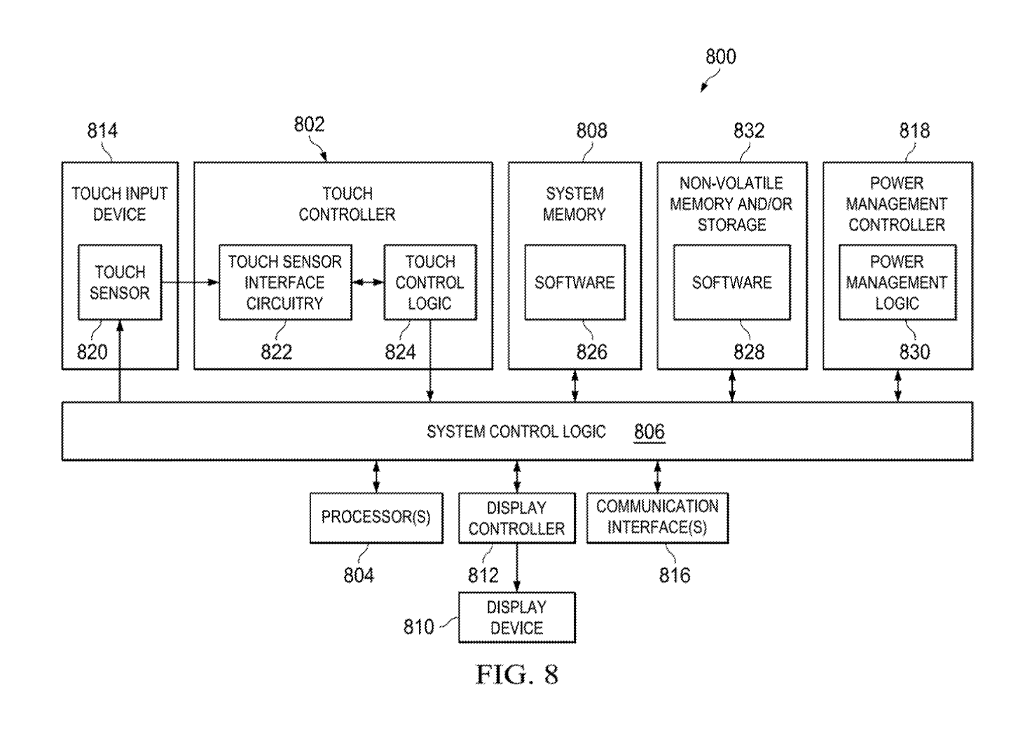

FIG. 8 is a simplified block diagram illustrating potential electronics and logic that may be associated with electronic devices 10a and 10b discussed herein. In at least one example embodiment, system 800 can include a touch controller 802, one or more processors 804, system control logic 806 coupled to at least one of processor(s) 804, system memory 808 coupled to system control logic 806, non-volatile memory and/or storage device(s) 832 coupled to system control logic 806, display controller 812 coupled to system control logic 806, display controller 812 coupled to a display device 810, power management controller 818 coupled to system control logic 806, and/or communication interfaces 816 coupled to system control logic 806.

Hence, the basic building blocks of any computer system (e.g., processor, memory, I/O, display etc.) can be used in conjunction with the teachings of the present disclosure. Certain components could be discrete or integrated into a System on Chip (SoC). Some general system implementations can include certain types of form factors in which system 800 is part of a more generalized enclosure. In alternate implementations, instead of notebook device/laptops, etc., certain alternate embodiments deal with mobile phones, tablet devices, etc.

System control logic 806, in at least one embodiment, can include any suitable interface controllers to provide for any suitable interface to at least one processor 804 and/or to any suitable device or component in communication with system control logic 806. System control logic 806, in at least one embodiment, can include one or more memory controllers to provide an interface to system memory 808. System memory 808 may be used to load and store data and/or instructions, for example, for system 800. System memory 808, in at least one embodiment, can include any suitable volatile memory, such as suitable dynamic random access memory (DRAM) for example. System control logic 806, in at least one embodiment, can include one or more I/O controllers to provide an interface to display device 810, touch controller 802, and non-volatile memory and/or storage device(s) 832.

Non-volatile memory and/or storage device(s) 832 may be used to store data and/or instructions, for example within software 828. Non-volatile memory and/or storage device(s) 832 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 818 may include power management logic 830 configured to control various power management and/or power saving functions. In at least one example embodiment, power management controller 818 is configured to reduce the power consumption of components or devices of system 800 that may either be operated at reduced power or turned off when the electronic device is in a closed configuration. For example, in at least one embodiment, when the electronic device is in a closed configuration, power management controller 818 performs one or more of the following: power down the unused portion of the display and/or any backlight associated therewith; allow one or more of processor(s) 804 to go to a lower power state if less computing power is required in the closed configuration; and shutdown any devices and/or components that are unused when an electronic device is in the closed configuration.

Communications interface(s) 816 may provide an interface for system 800 to communicate over one or more networks and/or with any other suitable device. Communications interface(s) 816 may include any suitable hardware and/or firmware. Communications interface(s) 816, in at least one example embodiment, may include, for example, a network adapter, a wireless network adapter, a telephone modem, and/or a wireless modem. System control logic 806, in at least one embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one embodiment, at least one processor 804 may be packaged together with logic for one or more controllers of system control logic 806. In at least one embodiment, at least one processor 804 may be packaged together with logic for one or more controllers of system control logic 806 to form a System in Package (SiP). In at least one embodiment, at least one processor 804 may be integrated on the same die with logic for one or more controllers of system control logic 806. For at least one embodiment, at least one processor 804 may be integrated on the same die with logic for one or more controllers of system control logic 806 to form a System on Chip (SoC).

For touch control, touch controller 802 may include touch sensor interface circuitry 822 and touch control logic 824. Touch sensor interface circuitry 822 may be coupled to detect touch input over a first touch surface layer and a second touch surface layer of a display (i.e., display device 810). Touch sensor interface circuitry 822 may include any suitable circuitry that may depend, for example, at least in part on the touch-sensitive technology used for a touch input device. Touch sensor interface circuitry 822, in one embodiment, may support any suitable multi-touch technology. Touch sensor interface circuitry 822, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 824 may be coupled to help control touch sensor interface circuitry 822 in any suitable manner to detect touch input over a first touch surface layer and a second touch surface layer. Touch control logic 824 for at least one example embodiment may also be coupled to output in any suitable manner digital touch input data corresponding to touch input detected by touch sensor interface circuitry 822. Touch control logic 824 may be implemented using any suitable logic, including any suitable hardware, firmware, and/or software logic (e.g., non-transitory tangible media), that may depend, for example, at least in part on the circuitry used for touch sensor interface circuitry 822. Touch control logic 824 for at least one embodiment may support any suitable multi-touch technology.

Touch control logic 824 may be coupled to output digital touch input data to system control logic 806 and/or at least one processor 804 for processing. At least one processor 804 for at least one embodiment may execute any suitable software to process digital touch input data output from touch control logic 824. Suitable software may include, for example, any suitable driver software and/or any suitable application software. As illustrated in FIG. 8, system memory 808 may store suitable software 826 and/or on-volatile memory and/or storage device(s).

Note that with the examples provided above, as well as numerous other examples provided herein, interaction may be described in terms of layers, protocols, interfaces, spaces, and environments more generally. However, this has been done for purposes of clarity and example only. In certain cases, it may be easier to describe one or more of the functionalities of a given set of flows by only referencing a limited number of components. It should be appreciated that the architectures discussed herein (and its teachings) are readily scalable and can accommodate a large number of components, as well as more complicated/sophisticated arrangements and configurations. Accordingly, the examples provided should not limit the scope or inhibit the broad teachings of the present disclosure, as potentially applied to a myriad of other architectures.

It is also important to note that a number of operations have been described as being executed concurrently with, or in parallel to, one or more additional operations. However, the timing of these operations may be altered considerably. The preceding examples and operational flows have been offered for purposes of example and discussion. Substantial flexibility is provided by the present disclosure in that any suitable arrangements, chronologies, configurations, and timing mechanisms may be provided without departing from the teachings provided herein.

It is also imperative to note that all of the Specifications, and relationships outlined herein (e.g., specific commands, timing intervals, supporting ancillary components, etc.) have only been offered for purposes of example and teaching only. Each of these may be varied considerably without departing from the spirit of the present disclosure, or the scope of the appended claims. The specifications apply to many varying and non-limiting examples and, accordingly, they should be construed as such. In the foregoing description, examples have been described. Various modifications and changes may be made to such examples without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark. Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### EXAMPLE EMBODIMENT IMPLEMENTATIONS

One particular example implementation of an electronic device may include activities associated with removably connecting a display portion to a keyboard portion using a cradle dock. The keyboard portion has about the same length and width as the display portion. Also, the cradle dock is slidably connected to a bearing rail located on the keyboard portion and a viewing angle of the display portion is changed when the cradle dock moves up or down the bearing rail. As the display portion is rotated away from a keyboard on the keyboard portion, the cradle dock may move along the bearing rail towards the keyboard portion. The bearing rail can be angled downward towards the keyboard. Also, a linkage may be rotatably connected to the cradle dock. The linkage can rotate when the viewing of the display portion is changed. The linkage can at least partially support the display portion. The first configuration is a clamshell configuration and the display portion can be removed and reattached in a second configuration, where the second configuration is a tablet configuration. When in the second configuration, the cradle dock has a relatively flat profile.

In another example implementation, a system is provided that includes means for removably connecting a display portion to a keyboard portion using a cradle dock. The keyboard portion has about the same length and width as the display portion and the cradle dock is slidably connected to a bearing rail located on the keyboard portion. A viewing angle of the display portion is changed when the cradle dock moves up or down the bearing rail.

### OTHER NOTES AND EXAMPLES

Example A1 is an electronic device that includes a display portion and a keyboard portion. The keyboard portion has about the same length and width as the display portion. The keyboard portion includes a cradle dock that allows the keyboard portion to be removably connected to the display portion in a first configuration and a viewing angle of the display portion is changed when the cradle dock is rotated about an axis of rotation with respect to the keyboard portion.

In Example A2, the subject matter of Example A1 may optionally include where the cradle dock moves along a bearing rail towards a keyboard as the display portion is rotated away from the keyboard on the keyboard portion.

In Example A3, the subject matter of any of the preceding ‘A’ Examples can optionally include where the bearing rail is angled downward towards the keyboard.

In Example A4, the subject matter of any of the preceding ‘A’ Examples can optionally include a linkage that is rotatably connected to the cradle dock. The linkage can rotate when the viewing of the display portion is changed and the linkage may at least partially support the display portion.

In Example A5, the subject matter of any of the preceding ‘A’ Examples can optionally include where the linkage is a kickstand support for the display portion.

In Example A6, the subject matter of any of the preceding ‘A’ Examples can optionally include where the first configuration is a clamshell configuration and the display portion can be removed and reattached in a second configuration. The second configuration can be a tablet configuration.

In Example A7, the subject matter of any of the preceding ‘A’ Examples can optionally include where the cradle dock has a relatively flat profile when in the second configuration.

Example AA1 can include an electronic device that includes a display portion, a keyboard portion (e.g., having about the same length and width as the display portion), a bearing rail located on the keyboard portion, and a cradle dock. The cradle dock allows the keyboard portion to be removably connected to the display portion in a first configuration. The cradle dock is slidably connected to the bearing rail and a viewing angle of the display portion is changed when the cradle dock moves up or down the bearing rail.

In Example AA2, the subject matter of any of the preceding ‘AA’ Examples can optionally include where the cradle dock moves along the bearing rail towards the keyboard portion as the display portion is rotated away from a keyboard on the keyboard portion.

In Example AA3, the subject matter of any of the preceding ‘AA’ Examples can optionally include where the bearing rail is angled downward towards the keyboard.

In Example AA4, the subject matter of any of the preceding ‘AA’ Examples can optionally include a linkage that is rotatably connected to the cradle dock. The linkage can rotate when the viewing of the display portion is changed and the linkage at least partially supports the display portion.

In Example AA5, the subject matter of any of the preceding ‘AA’ Examples can optionally include where the linkage is a kickstand support for the display portion.

In Example AA6, the subject matter of any of the preceding ‘AA’ Examples can optionally include where the first configuration is a clamshell configuration and the display portion can be removed and reattached in a second configuration, where the second configuration is a tablet configuration.

In Example AA7, the subject matter of any of the preceding ‘AA’ Examples can optionally include where the cradle dock has a relatively flat profile when in the second configuration.

Example M1 is a method that includes receiving a display portion at a cradle dock; and receiving a force at the cradle dock to be translated forward on a linear bearing (e.g., a bearing rail, one or more bearings, etc.) proximate to a keyboard portion that is capable of being removably connected to the display portion.

In Example M2, the subject matter of any of the preceding ‘M’ Examples can optionally operate such that, as the display portion is rotated away from a keyboard on the keyboard portion, the cradle dock moves along the linear bearing towards the keyboard. In Example M3, the subject matter of any of the preceding ‘M’ Examples can optionally include applying torque or resistance to movement of the cradle dock when an electronic device, which includes the keyboard portion and the display portion, is in a first configuration.

In Example M4, the subject matter of any of the preceding ‘M’ Examples can optionally include controlling rotation of the display portion using a linkage that is rotatably connected to the cradle dock and that at least partially supports the display portion. In Example M4, the subject matter of any of the preceding ‘M’ Examples can optionally have the cradle dock being slidably connected to the linear bearing and a viewing angle of the display portion being changed when the cradle dock moves up or down the linear bearing. The display portion can expose a rear portion of the keyboard portion, as it rotates to an open position.

An Example System S1 can include means for receiving a display portion; and means for receiving a force to be translated forward on a linear bearing proximate to a keyboard portion that is capable of being removably connected to the display portion. In Example S2, the subject matter of any of the preceding ‘S’ Examples can optionally include means for applying torque or resistance to movement of a cradle dock when an electronic device, which includes the keyboard portion and the display portion, is in a first configuration. In Example S3, the subject matter of any of the preceding ‘S’ Examples can optionally include means for controlling rotation of the display portion using a linkage that is rotatably connected to the cradle dock and that at least partially supports the display portion. The display portion can expose a rear portion of the keyboard portion, as it rotates to an open position.

Example X1 is a machine-readable storage medium including machine-readable instructions to implement a method or realize an apparatus as in any one of the Examples A1-A8, AA1-AA6, M1-M6. Example Y1 is an apparatus comprising means for performing of any of the Example methods M1-M6. In Example Y2, the subject matter of Example Y1 can optionally include the means for performing the method comprising a processor and a memory. In Example Y3, the subject matter of Example Y2 can optionally include the memory comprising machine-readable instructions.

1-24. (canceled)

25. An electronic device, comprising:
a display portion; and
a keyboard portion that includes a cradle dock that allows the keyboard portion to be removably connected to the display portion in a first configuration, wherein a viewing angle of the display portion is changed when the cradle dock is rotated about an axis of rotation with respect to the keyboard portion.

26. The electronic device of claim 25, wherein the cradle dock moves along a bearing rail towards the keyboard portion as the display portion is rotated away from a keyboard on the keyboard portion.

27. The electronic device of claim 26, wherein the bearing rail is angled downward towards the keyboard.

28. The electronic device of claim 25, further comprising a linkage that is rotatably connected to the cradle dock and that at least partially supports the display portion.

29. The electronic device of claim 28, wherein the linkage is a kickstand support for the display portion.

30. The electronic device of claim 27, wherein the first configuration is a clamshell configuration and the display portion can be removed and reattached in a second configuration, wherein the second configuration is a tablet configuration.

31. The electronic device of claim 30, wherein the cradle dock has a relatively flat profile when in the second configuration.

32. An electronic device, comprising:
a display portion;
a keyboard portion;
a bearing rail located on the keyboard portion; and
a cradle dock that allows the keyboard portion to be removably connected to the display portion in a first configuration, wherein the cradle dock is slidably connected to the bearing rail and a viewing angle of the display portion is changed when the cradle dock moves up or down the bearing rail.

33. The electronic device of claim 32, wherein the cradle dock moves along the bearing rail towards the keyboard portion as the display portion is rotated away from a keyboard on the keyboard portion.

34. The electronic device of claim 33, wherein the bearing rail is angled downward towards the keyboard.

35. The electronic device of claim 32, further comprising a linkage that is rotatably connected to the cradle dock and that at least partially supports the display portion.

36. The electronic device of claim 35, wherein the linkage is a kickstand support for the display portion.

37. The electronic device of claim 32, wherein the first configuration is a clamshell configuration and the display portion can be removed and reattached in a second configuration, wherein the second configuration is a tablet configuration.

38. The electronic device of claim 37, wherein the cradle dock has a relatively flat profile when in the second configuration.

39. A method, comprising:
receiving a display portion at a cradle dock; and
receiving a force at the cradle dock to be translated forward on a linear bearing proximate to a keyboard portion that is capable of being removably connected to the display portion.

40. The method of claim 39, wherein as the display portion is rotated away from a keyboard on the keyboard portion, the cradle dock moves along the linear bearing towards the keyboard.

41. The method of claim 39, further comprising:
applying torque or resistance to movement of the cradle dock when an electronic device, which includes the keyboard portion and the display portion, is in a first configuration.

42. The method of claim 39, further comprising:
controlling rotation of the display portion using a linkage that is rotatably connected to the cradle dock and that at least partially supports the display portion.

43. The method of claim 39, wherein the cradle dock is slidably connected to the linear bearing and a viewing angle of the display portion is changed when the cradle dock moves up or down the linear bearing.

44. The method of claim 39, wherein the display portion exposes a rear portion of the keyboard portion, as it rotates to an open position.

45. A system, comprising:
means for receiving a display portion; and
means for receiving a force to be translated forward on a linear bearing proximate to a keyboard portion that is capable of being removably connected to the display portion.

46. The system of claim 45, further comprising:
means for applying torque or resistance to movement of a cradle dock when an electronic device, which includes the keyboard portion and the display portion, is in a first configuration.

47. The system of claim 46, further comprising:
means for controlling rotation of the display portion using a linkage that is rotatably connected to the cradle dock and that at least partially supports the display portion.

48. The system of claim 45, wherein the display portion exposes a rear portion of the keyboard portion, as it rotates to an open position.
